(19) United States
(12) Patent Application Publication
(10) Pub. No.: US 2010/0059607 A1
(43) Pub. Date: Mar. 11, 2010

(54) FLUID EJECTION DEVICE

(76) Inventor: Shi-Chang CHANG, Taipei (TW)

Correspondence Address: Muncy, Geissler, Olds & Lowe, PLLC, P.O. BOX 1364, FAIRFAX, VA, 22038-1364, US

(21) Appl. No.: 12/205,033

(22) Filed: Sep. 5, 2008

(51) Int. Cl. B05B 7/04; B05B 1/00

(52) U.S. Cl. 239/398; 239/589

(57) ABSTRACT

A fluid ejection device is provided. The fluid ejection device includes at least one accelerating unit disposed inside the device for accelerating the fluid before it is ejected out, for increasing the velocity of the ejected fluid.

### BACKGROUND OF THE INVENTION

1. Field of the Invention

The present invention relates generally to a fluid ejection device, and more particularly to a two-fluid sprayer including an accelerating unit having a reduced cross-section area disposed therein, for accelerating the fluid to be ejected out, the accelerating unit being adapted for uniformly ejecting the two fluids.

2. The Prior Arts

A nozzle is an application of the liquid atomizing principle. Nozzles are typically divided into a single fluid type and a two-fluid type. A single fluid type nozzle is also known as a liquid pressure nozzle, which employs a pump to increase the pressure of the liquid, so as to drive the liquid to pass through a specific structure of the nozzle and eject from an exit of the nozzle. Such a nozzle usually produces sprayed particles having relative large sizes. When it is desired to obtain sprayed particles having smaller sizes, the pressure should be further increased and/or a nozzle having a smaller aperture size should be used. However, in order to further increase the pressure of the liquid, a stronger pump must be used, and when using a nozzle having a smaller aperture, the nozzle is more likely to be jammed. A two-fluid type nozzle is also known as a gas assisted nozzle, which employs high pressure gas, e.g., gas, for impacting the liquid and destroying the surface tension of the liquid, and assisting the atomization of the liquid. The atomized liquid particles are then dispersed out from an exit. Comparing with the single fluid nozzle, the two-fluid nozzle is adapted for producing smaller particles with a nozzle having a larger aperture size, and therefore the two-fluid nozzle is not likely to be jammed, and the flow rate of the fluid can be adjusted within a wider range.

A typical two-fluid nozzle includes an atomizing structure which can be either an internal atomizing type or an external atomizing type. The external atomizing type is featured in directly impacting the liquid with the gas after the liquid dispatching from the nozzle, thus the gas and the liquid are mixed into an atomized mixture. The external atomizing type configures the atomized mixture at an outside of the nozzle, and therefore there is no pressure to be further utilized. As to the internal atomizing type, it is featured in supplying the gas inside a body of the nozzle, and the gas is guided to impact the liquid, so that the liquid and the gas are combined into a mixture by a mixing chamber. The mixture is then configured into a desired dispersing mode by different types of exit orifices (a round hole shape, a strip shape opening, etc.) and sprayed onto a desired surface. The external atomizing type is often used for moisturizing the environment, gas cooling, or the like, while the internal atomizing type is often used for workpiece washing, liquid distributing, and billet cooling, etc., in accordance to the design of the exit orifice. Regarding the current two-fluid nozzle, it is difficult to simultaneously satisfy desires for less gas consumption, smaller liquid particle sizes, and greater impact force, because these three conditions are interacted each other. For example, less gas consumption likely leads to a smaller impact force and larger liquid particle sizes, or otherwise, smaller particle liquid sizes and a greater impact force usually demand for more gas consumption. When a large amount of gas is consumed, the consumed gas takes away a large percentage of liquid particles. Or if an orifice having a smaller aperture is used for increasing the velocity of the particles and improving the impact force, the gas can be accelerated at most approaching to the sonic velocity. As such, using an orifice having a smaller aperture would not satisfy all of the foregoing desired three conditions.

### SUMMARY OF THE INVENTION

The present invention provides a fluid ejection device having an accelerating unit. The fluid ejection device can be an internal atomizing type two-fluid sprayer. The two-fluid sprayer includes a nozzle. The nozzle includes a mixing chamber for allowing a gas impacting a liquid. The mixing chamber is equipped with an accelerating unit therein. The accelerating unit can be a Venturi tube as shown in FIG. 7, or an orifice as shown in FIG. 8. The accelerating unit is adapted for increasing a velocity of liquid particles without increasing a gas pressure, and recycling consumed gas. By employing such an accelerating unit, the fluid ejection device can use a lower gas pressure for atomizing, and consumes less gas, thus improving the efficiency of pressure utilization.

A primary objective of the present invention is to provide a fluid ejection device having one or a multi-segment type accelerating unit disposed in a body of the fluid ejection device, for accelerating a fluid velocity. The fluid ejection device can be a two-fluid sprayer. In a conventional two-fluid sprayer, the compressed gas can be utilized only once, and most of the compressed gas disappears after the once utilization of accelerating. On the contrary, according to the present invention, because of the employment of the accelerating unit, the utilized gas can be repetitively recycled for repetitively accelerating the liquid particles, for achieving a desired particle velocity. When the particle velocity and the particle sizes satisfy the desire, then the pressure of the gas can be reduced. As such, the present invention employing a nozzle having an accelerating unit is adapted for increasing the particle velocity without increasing the gas pressure, and thus consuming less gas.

Another objective of the present invention is to simultaneously obtain a greater impact force and smaller liquid particle sizes by employing an accelerating unit. Liquid particles having a higher velocity are likely to be further split to achieve finer sizes. Particles having a higher velocity and finer sizes often correspond to a higher working efficiency in certain processing, such as billet cooling in iron and steel industry, washing LCD glass substrate, environment moisturizing and disinfecting.

The liquid ejection device employing the accelerating unit can be a gas knife type atomizer as shown in FIGS. 5 and 6. The gas knife type atomizer includes an atomizing mechanism and at least one accelerating unit. In such a way, the liquid ejection device can produce a two-fluid ejection flow which can be accelerated and homogenized by the accelerating unit. Such a two-fluid ejection flow achieves an atomizing effect almost completely uniform and perpendicular with a surface desired to be sprayed thereon, thus providing a solution for the difficulty of multiple fan-shaped two-fluid nozzles producing uneven atomizing effect.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram illustrating a two-fluid nozzle structure having no accelerating unit.

FIG. 2 is a schematic diagram illustrating a two-fluid nozzle employing a Venturi tube as an accelerating unit according to an embodiment of the present invention.

FIG. 3 is a schematic diagram illustrating a two-fluid nozzle employing two Venturi tubes as an accelerating unit according to an embodiment of the present invention.

FIG. 4a is a schematic diagram illustrating a two-fluid nozzle employing an orifice as an accelerating unit according to an embodiment of the present invention.

FIG. 4b is a schematic diagram illustrating a two-fluid nozzle employing two orifices as an accelerating unit according to an embodiment of the present invention.

FIG. 5 is a schematic diagram illustrating a gas knife type atomizer employing a Verturi tube as an accelerating unit according to an embodiment of the present invention.

FIG. 6 is a schematic diagram illustrating a gas knife type atomizer employing an orifice as an accelerating unit according to an embodiment of the present invention.

FIG. 7 is a schematic diagram illustrating a Venturi tube.

FIG. 8 is a schematic diagram illustrating an orifice.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention, a fluid ejection device, and specifically, a two-fluid sprayer.

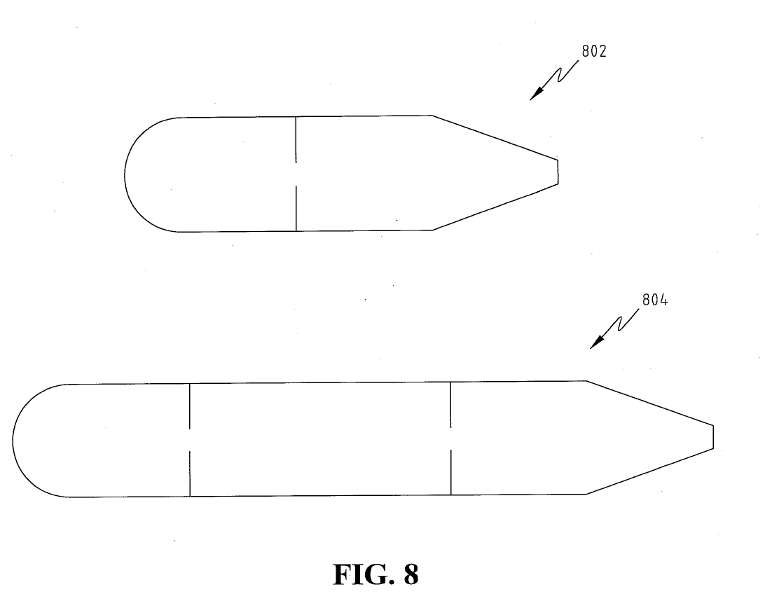

The two-fluid sprayer is an internal atomizing type sprayer. The two-fluid sprayer includes a mixing chamber for allowing a gas impacting a liquid therein. The mixing chamber is disposed with an accelerating unit having a reduced cross-section area. The gas and the liquid enter the mixing chamber, and are uniformly mixed, and then pass through the accelerating unit. The accelerating unit for example can be a Venturi tube 702 (or 704) having an inside wall convergent at one end and gradually divergent at another end. The convergent end of the accelerating unit is connected to an exit of the mixing chamber. As such, when the liquid or the gas flows through the convergent inside wall, because of the smaller cross-section area thereof, the flow velocity of the two-fluid is accelerated. The accelerating unit can also be an orifice or an opening 802 (or 804) as shown in FIG. 8, which can also accelerate the flow velocity. Hence, an embodiment is given below for comparing a particle velocity of a nozzle employing an accelerating unit according to the present invention with that of the conventional nozzle that does not include such an accelerating unit at the exits of the nozzles, respectively. When the liquid is impacted by the gas to configure very fine liquid particles. Such liquid particles have become inconsecutive phase. As such, when the liquid particles reach the exit of the nozzle, the velocity thereof can not be measured by the conservation law of momentum (m₁v₁=m₂v₂, m representing a mass of a particle, v representing a velocity of the particle). Instead, the velocity should be calculated in accordance with the conservation law of momentum, the conservation law of mass, and the conservation law of energy. The principle is to be further described herebelow.

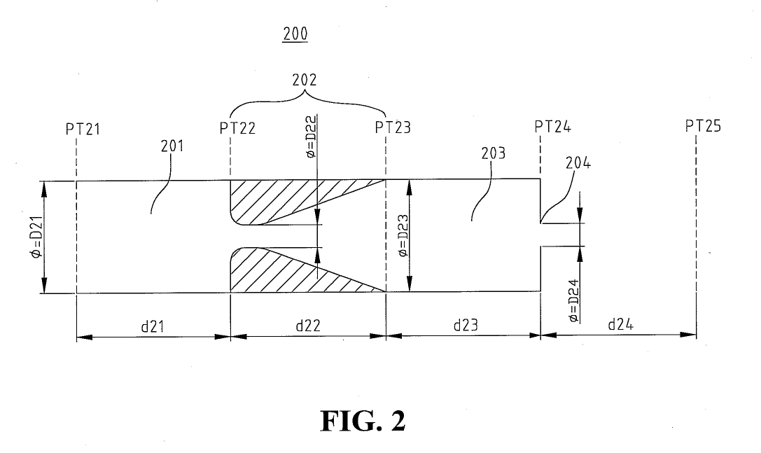

According to a preferred embodiment of the present invention, referring to FIG. 2, it illustrates a two-fluid nozzle 200 including a Venturi tube.

The liquid particle velocity of the conventional two-fluid nozzle having no accelerating unit is to be compared with the liquid particle velocity at the exit of the two-fluid nozzle employing an accelerating unit according to the embodiment of the present invention.

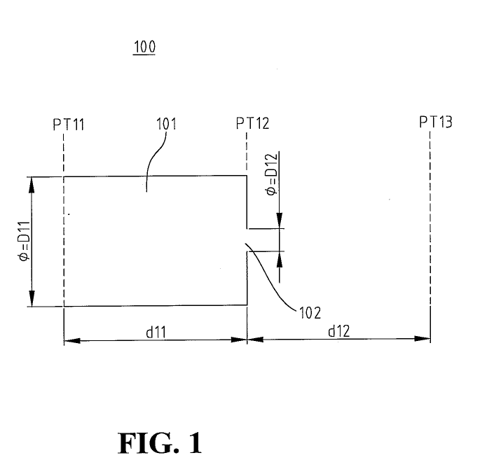

FIG. 1 illustrates a conventional two-fluid nozzle 100 having no accelerating unit. The two-fluid nozzle 100 includes left to right sequentially disposed a mixing chamber 101 and an exit orifice 102.

Conditions of the conventional two-fluid nozzle 100 having no accelerating unit are listed below:

(a) in the mixing chamber 101,
gas velocity: 15 m/s;
liquid particle velocity: 7.5 m/s; liquid particle size: 30 μm;
temperature: 25° C.;
pressure: 3 kg/cm²G;
inner diameter of chamber, D11: 6 m/m;

(b) length from PT11 to PT12, d11: 5 mm,

(c) at the exit 102,
exit diameter, D12: 1.8 m/m;

(d) length from PT12 to PT13, d12: 5 mm.

FIG. 2 is a schematic diagram illustrating the two-fluid nozzle 200 employing a Venturi tube 202 as an accelerating unit according to an embodiment of the present invention. The two-fluid nozzle 200 includes left-to-right sequentially disposed a mixing chamber 201, a Venturi tube 202, a recovery portion 203, and an exit orifice 204.

Conditions of the two-fluid nozzle 200 employing a Venturi tube 202 are listed below:

(a) in the mixing chamber 201,
gas velocity: 15 m/s;
liquid particle velocity: 7.5 m/s;
liquid particle size: 30 μm;
temperature: 25° C.;
pressure: 3 kg/cm²G;
inner diameter of chamber, D21: 6 m/m;

(b) length from PT21 to PT22, d21: 5 mm,

(c) Venturi tube 202,
minimum diameter, D22: 1.8 m/m;

(d) length from PT22 to PT23, d22: 5 mm;

(e) recovery portion 203,
inner chamber diameter, D23: 6 m/m;

(f) length from PT23 to PT24, d23: 5 mm;

(g) exit orifice 204,
exit orifice diameter, D24: 1.8 m/m

(h) length from PT24 to PT25, d24: 5 mm.

In accordance the foregoing embodiment, all conditions except the accelerating unit of the conventional nozzle and the present invention are equivalent, and it is assumed that the liquid particles maintain their size (30 μm) unchanged when accelerating the particle velocity. According to a one-dimensional calculation, and numerical analysis is made to the foregoing, results are listed in Tables 1-1 through 1-2, and Tables 2-1 through 2-4.

TABLE 1-1

| | | |
|---|---|---|
| PRESSURE = 0.3920E+06 PA | TEMPERATURE = 298.00 K | VELOCITY = 15.0000 M/S |
| INLET DIAMETER = 0.0060 M | EXIT DIAMETER = 0.0018 M | NOZZLE LENGTH = 0.0100 M |

| DISTANCE | VELOCITY | GAS TEMP. | PRESSURE | PARTICLE VEL. | PARTICLE TEMP. |
|---|---|---|---|---|---|
| (M) | (M/S) | (K) | (Pa) | (M/S) | (K) |
| 0.0000 | 15.0000 | 298.00 | 0.3920E+06 | 7.5000 | 298.00 |
| 0.0002 | 15.0840 | 298.00 | 0.3920E+06 | 7.7981 | 298.00 |
| 0.0004 | 15.3375 | 297.99 | 0.3919E+06 | 8.0804 | 298.00 |
| 0.0006 | 15.7692 | 297.98 | 0.3919E+06 | 8.3581 | 298.00 |
| 0.0008 | 16.3944 | 297.97 | 0.3918E+06 | 8.6411 | 298.00 |
| 0.0010 | 17.2353 | 297.95 | 0.3917E+06 | 8.9393 | 298.00 |
| 0.0012 | 18.3230 | 297.93 | 0.3916E+06 | 9.2629 | 298.00 |
| 0.0014 | 19.6984 | 297.91 | 0.3915E+06 | 9.6231 | 297.99 |
| 0.0016 | 21.4149 | 297.87 | 0.3913E+06 | 10.0330 | 297.99 |
| 0.0018 | 23.5417 | 297.82 | 0.3910E+06 | 10.5079 | 297.98 |
| 0.0020 | 26.1667 | 297.76 | 0.3906E+06 | 11.0662 | 297.98 |
| 0.0022 | 29.4014 | 297.67 | 0.3901E+06 | 11.7302 | 297.97 |
| 0.0024 | 33.3861 | 297.55 | 0.3894E+06 | 12.5270 | 297.95 |
| 0.0026 | 38.2949 | 297.38 | 0.3885E+06 | 13.4881 | 297.93 |
| 0.0028 | 44.3412 | 297.13 | 0.3871E+06 | 14.6518 | 297.90 |
| 0.0030 | 51.7799 | 296.79 | 0.3852E+06 | 16.0624 | 297.86 |
| 0.0032 | 60.9054 | 296.29 | 0.3825E+06 | 17.7701 | 297.81 |
| 0.0034 | 72.0396 | 295.57 | 0.3785E+06 | 19.8299 | 297.74 |
| 0.0036 | 85.5047 | 294.54 | 0.3730E+06 | 22.2976 | 297.64 |
| 0.0038 | 101.5701 | 293.09 | 0.3652E+06 | 25.2247 | 297.50 |
| 0.0040 | 120.3645 | 291.07 | 0.3546E+06 | 28.6476 | 297.32 |
| 0.0042 | 141.7343 | 288.36 | 0.3406E+06 | 32.5750 | 297.08 |
| 0.0044 | 165.0151 | 284.92 | 0.3234E+06 | 36.9707 | 296.78 |
| 0.0046 | 188.6433 | 280.89 | 0.3038E+06 | 41.7319 | 296.41 |
| 0.0048 | 209.4614 | 276.93 | 0.2846E+06 | 46.6648 | 295.99 |
| 0.0050 | 222.0081 | 274.41 | 0.2710E+06 | 51.4625 | 295.55 |
| 0.0052 | 43.6589 | 298.02 | 0.3186E+06 | 51.3653 | 295.58 |

TABLE 1-2

| | | | | | |
|---|---|---|---|---|---|
| 0.0054 | 43.6574 | 298.01 | 0.3186E+06 | 51.3166 | 295.60 |
| 0.0056 | 43.6560 | 298.00 | 0.3186E+06 | 51.2683 | 295.61 |
| 0.0058 | 43.6545 | 297.99 | 0.3186E+06 | 51.2203 | 295.63 |
| 0.0060 | 43.6531 | 297.98 | 0.3186E+06 | 51.1727 | 295.64 |
| 0.0062 | 43.6518 | 297.97 | 0.3186E+06 | 51.1253 | 295.66 |
| 0.0064 | 43.6504 | 297.96 | 0.3186E+06 | 51.0783 | 295.67 |
| 0.0066 | 43.6491 | 297.95 | 0.3186E+06 | 51.0316 | 295.69 |
| 0.0068 | 43.6479 | 297.94 | 0.3186E+06 | 50.9852 | 295.70 |
| 0.0070 | 43.6466 | 297.93 | 0.3186E+06 | 50.9392 | 295.72 |
| 0.0072 | 43.6454 | 297.92 | 0.3186E+06 | 50.8934 | 295.73 |
| 0.0074 | 43.6442 | 297.91 | 0.3186E+06 | 50.8480 | 295.75 |
| 0.0076 | 43.6430 | 297.91 | 0.3186E+06 | 50.8029 | 295.76 |
| 0.0078 | 43.6418 | 297.90 | 0.3186E+06 | 50.7580 | 295.78 |
| 0.0080 | 43.6407 | 297.89 | 0.3186E+06 | 50.7135 | 295.79 |
| 0.0082 | 43.6396 | 297.88 | 0.3186E+06 | 50.6693 | 295.80 |
| 0.0084 | 43.6385 | 297.87 | 0.3186E+06 | 50.6254 | 295.82 |
| 0.0086 | 43.6375 | 297.86 | 0.3186E+06 | 50.5818 | 295.83 |
| 0.0088 | 43.6365 | 297.85 | 0.3186E+06 | 50.5384 | 295.84 |
| 0.0090 | 43.6355 | 297.85 | 0.3186E+06 | 50.4954 | 295.86 |
| 0.0092 | 43.6345 | 297.84 | 0.3186E+06 | 50.4527 | 295.87 |
| 0.0094 | 43.6335 | 297.83 | 0.3186E+06 | 50.4102 | 295.88 |
| 0.0096 | 43.6326 | 297.82 | 0.3186E+06 | 50.3680 | 295.90 |
| 0.0098 | 43.6317 | 297.81 | 0.3186E+06 | 50.3262 | 295.91 |
| 0.0100 | 43.6308 | 297.81 | 0.3186E+06 | 50.2845 | 295.92 |

Stop-Program terminated

TABLE 2-1

| | | |
|---|---|---|
| PRESSURE = 0.3920E+06 PA | TEMPERATURE = 298.00 K | VELOCITY = 15.0000 M/S |
| INLET DIAMETER = 0.0060 M | EXIT DIAMETER = 0.0018 M | NOZZLE LENGTH = 0.0100 M |

| DISTANCE | VELOCITY | GAS TEMP. | PRESSURE | PARTICLE VEL. | PARTICLE TEMP. |
|---|---|---|---|---|---|
| (M) | (M/S) | (K) | (Pa) | (M/S) | (K) |
| 0.0000 | 15.0000 | 298.00 | 0.3920E+06 | 7.5000 | 298.00 |
| 0.0002 | 15.0840 | 298.00 | 0.3920E+06 | 7.7981 | 298.00 |
| 0.0004 | 15.3375 | 297.99 | 0.3919E+06 | 8.0804 | 298.00 |
| 0.0006 | 15.7692 | 297.98 | 0.3919E+06 | 8.3581 | 298.00 |
| 0.0008 | 16.3944 | 297.97 | 0.3918E+06 | 8.6411 | 298.00 |
| 0.0010 | 17.2353 | 297.95 | 0.3917E+06 | 8.9393 | 298.00 |
| 0.0012 | 18.3230 | 297.93 | 0.3916E+06 | 9.2629 | 298.00 |
| 0.0014 | 19.6984 | 297.91 | 0.3915E+06 | 9.6231 | 297.99 |
| 0.0016 | 21.4149 | 297.87 | 0.3913E+06 | 10.0330 | 297.99 |
| 0.0018 | 23.5417 | 297.82 | 0.3910E+06 | 10.5079 | 297.98 |
| 0.0020 | 26.1667 | 297.76 | 0.3906E+06 | 11.0662 | 297.98 |
| 0.0022 | 29.4014 | 297.67 | 0.3901E+06 | 11.7302 | 297.97 |
| 0.0024 | 33.3861 | 297.55 | 0.3894E+06 | 12.5270 | 297.95 |
| 0.0026 | 38.2949 | 297.38 | 0.3885E+06 | 13.4881 | 297.93 |
| 0.0028 | 44.3412 | 297.13 | 0.3871E+06 | 14.6518 | 297.90 |
| 0.0030 | 51.7799 | 296.79 | 0.3852E+06 | 16.0624 | 297.86 |
| 0.0032 | 60.9054 | 296.29 | 0.3825E+06 | 17.7701 | 297.81 |
| 0.0034 | 72.0396 | 295.57 | 0.3785E+06 | 19.8299 | 297.74 |
| 0.0036 | 85.5047 | 294.54 | 0.3730E+06 | 22.2976 | 297.64 |
| 0.0038 | 101.5701 | 293.09 | 0.3652E+06 | 25.2247 | 297.50 |
| 0.0040 | 120.3645 | 291.07 | 0.3546E+06 | 28.6476 | 297.32 |
| 0.0042 | 141.7343 | 288.36 | 0.3406E+06 | 32.5750 | 297.08 |
| 0.0044 | 165.0151 | 284.92 | 0.3234E+06 | 36.9707 | 296.78 |
| 0.0046 | 188.6433 | 280.89 | 0.3038E+06 | 41.7319 | 296.41 |
| 0.0048 | 209.4614 | 276.93 | 0.2846E+06 | 46.6648 | 295.99 |
| 0.0050 | 222.0081 | 274.41 | 0.2710E+06 | 51.4625 | 295.55 |
| 0.0052 | 220.5595 | 274.89 | 0.2683E+06 | 55.7403 | 295.16 |
| 0.0054 | 205.4792 | 278.20 | 0.2762E+06 | 59.1998 | 294.86 |

TABLE 2-2

| | | | | | |
|---|---|---|---|---|---|
| 0.0056 | 182.9338 | 282.62 | 0.2894E+06 | 61.7639 | 294.65 |
| 0.0058 | 158.4672 | 286.81 | 0.3030E+06 | 63.5275 | 294.53 |
| 0.0060 | 135.1195 | 290.22 | 0.3149E+06 | 64.6537 | 294.47 |
| 0.0062 | 114.2362 | 292.80 | 0.3244E+06 | 65.3112 | 294.44 |
| 0.0064 | 96.2492 | 294.68 | 0.3315E+06 | 65.6470 | 294.44 |
| 0.0066 | 81.1219 | 296.00 | 0.3366E+06 | 65.7793 | 294.45 |
| 0.0068 | 68.5948 | 296.93 | 0.3403E+06 | 65.7998 | 294.46 |
| 0.0070 | 52.3218 | 297.57 | 0.3429E+06 | 65.7745 | 294.47 |
| 0.0072 | 49.9433 | 298.01 | 0.3447E+06 | 65.6909 | 294.49 |
| 0.0074 | 43.1308 | 298.31 | 0.3460E+06 | 65.5397 | 294.52 |
| 0.0076 | 37.5989 | 298.52 | 0.3469E+06 | 65.3228 | 294.55 |
| 0.0078 | 33.1080 | 298.67 | 0.3476E+06 | 65.0464 | 294.58 |
| 0.0080 | 29.4623 | 298.77 | 0.3418E+06 | 64.7184 | 294.62 |
| 0.0082 | 26.5038 | 298.85 | 0.3485E+06 | 64.3468 | 294.66 |
| 0.0084 | 24.1068 | 298.90 | 0.3488E+06 | 63.9388 | 294.70 |
| 0.0086 | 22.1721 | 298.94 | 0.3490E+06 | 63.5014 | 294.74 |
| 0.0088 | 20.6219 | 298.97 | 0.3492E+06 | 63.0406 | 294.78 |
| 0.0090 | 19.3959 | 298.99 | 0.3493E+06 | 62.5617 | 294.82 |
| 0.0092 | 18.4478 | 299.00 | 0.3494E+06 | 62.0696 | 294.87 |
| 0.0094 | 17.7428 | 299.01 | 0.3495E+06 | 61.5686 | 294.91 |
| 0.0096 | 17.2557 | 299.01 | 0.3496E+06 | 61.0625 | 294.95 |
| 0.0098 | 16.9693 | 299.01 | 0.3496E+06 | 60.5551 | 294.99 |
| 0.0100 | 16.8737 | 299.01 | 0.3497E+06 | 60.0497 | 295.04 |

Stop-Program terminated

TABLE 2-3

| | | |
|---|---|---|
| PRESSURE 0.3497E+06 PA | TEMPERATURE = 299.01 K | VELOCITY = 16.8737 M/S |
| INLET DIAMETER = 0.0060 M | EXIT DIAMETER = 0.0018 M | NOZZLE LENGTH = 0.0100 M |

| DISTANCE | VELOCITY | GAS TEMP. | PRESSURE | PARTICLE VEL. | PARTICLE TEMP. |
|---|---|---|---|---|---|
| (M) | (M/S) | (K) | (Pa) | (M/S) | (K) |
| 0.0000 | 16.8737 | 299.01 | 0.3497E+06 | 60.0497 | 295.04 |
| 0.0002 | 16.9656 | 299.00 | 0.3497E+06 | 59.5500 | 295.08 |
| 0.0004 | 17.2481 | 298.99 | 0.3497E+06 | 59.0589 | 295.12 |
| 0.0006 | 17.7310 | 298.98 | 0.3497E+06 | 58.5800 | 295.16 |
| 0.0008 | 18.4313 | 298.96 | 0.3497E+06 | 58.1168 | 295.20 |
| 0.0010 | 19.3740 | 298.94 | 0.3497E+06 | 57.6732 | 295.24 |
| 0.0012 | 20.5936 | 298.91 | 0.3496E+06 | 57.2533 | 295.28 |
| 0.0014 | 22.1362 | 298.86 | 0.3495E+06 | 56.8616 | 295.32 |
| 0.0016 | 24.0616 | 298.81 | 0.3494E+06 | 56.5034 | 295.36 |
| 0.0018 | 26.4473 | 298.74 | 0.3492E+06 | 56.1841 | 295.39 |
| 0.0020 | 29.3920 | 298.65 | 0.3488E+06 | 55.9096 | 295.42 |
| 0.0022 | 33.0207 | 298.53 | 0.3484E+06 | 55.6858 | 295.45 |
| 0.0024 | 37.4911 | 298.36 | 0.3478E+06 | 55.5184 | 295.48 |
| 0.0026 | 42.9988 | 298.12 | 0.3469E+06 | 55.4106 | 295.50 |
| 0.0028 | 49.7839 | 297.80 | 0.3456E+06 | 55.3611 | 295.51 |
| 0.0030 | 58.1337 | 297.35 | 0.3438E+06 | 55.3550 | 295.52 |
| 0.0032 | 68.3794 | 296.69 | 0.3412E+06 | 55.4052 | 295.53 |
| 0.0034 | 80.8911 | 295.75 | 0.3374E+06 | 55.5769 | 295.53 |
| 0.0036 | 96.0524 | 294.41 | 0.3319E+06 | 55.9508 | 295.53 |
| 0.0038 | 114.2179 | 292.50 | 0.3241E+06 | 56.6253 | 295.50 |
| 0.0040 | 135.6493 | 289.83 | 0.3133E+06 | 57.7110 | 295.43 |
| 0.0042 | 160.4263 | 286.20 | 0.2987E+06 | 59.3169 | 295.32 |
| 0.0044 | 188.3280 | 281.40 | 0.2799E+06 | 61.5271 | 295.14 |
| 0.0046 | 218.6468 | 275.34 | 0.2569E+06 | 64.3709 | 294.87 |
| 0.0048 | 249.6244 | 268.25 | 0.2314E+06 | 67.7930 | 294.51 |
| 0.0050 | 275.2650 | 261.72 | 0.2085E+06 | 71.5983 | 294.06 |
| 0.0052 | 51.8910 | 298.13 | 0.2682E+06 | 71.4143 | 294.10 |

TABLE 2-4

| | | | | | |
|---|---|---|---|---|---|
| 0.0054 | 51.8872 | 298.12 | 0.2682E+06 | 71.2973 | 294.12 |
| 0.0056 | 51.8835 | 298.11 | 0.2682E+06 | 71.1811 | 294.15 |
| 0.0058 | 51.8798 | 298.10 | 0.2682E+06 | 71.0656 | 294.17 |
| 0.0060 | 51.8761 | 298.09 | 0.2683E+06 | 70.9508 | 294.19 |
| 0.0062 | 51.8725 | 298.08 | 0.2683E+06 | 70.8368 | 294.22 |
| 0.0064 | 51.8690 | 298.07 | 0.2683E+06 | 70.7235 | 294.24 |
| 0.0066 | 51.8655 | 298.06 | 0.2683E+06 | 70.6110 | 294.26 |
| 0.0068 | 518620 | 298.05 | 0.2683E+06 | 70.4992 | 294.29 |
| 0.0070 | 51.8586 | 298.04 | 0.2683E+06 | 70.3882 | 294.31 |
| 0.0072 | 51.8552 | 298.02 | 0.2683E+06 | 70.2779 | 294.33 |
| 0.0074 | 51.8519 | 298.01 | 0.2683E+06 | 70.1683 | 294.35 |
| 0.0076 | 51.8486 | 298.00 | 0.2683E+06 | 70.0594 | 294.38 |
| 0.0078 | 51.8453 | 297.99 | 0.2683E+06 | 69.9512 | 294.40 |
| 0.0080 | 51.8421 | 297.98 | 0.2686E+06 | 69.8437 | 294.42 |
| 0.0082 | 51.8390 | 297.97 | 0.2683E+06 | 69.7369 | 294.44 |
| 0.0084 | 51.8359 | 297.96 | 0.2684E+06 | 69.6309 | 294.46 |
| 0.0086 | 51.8328 | 297.95 | 0.2684E+06 | 69.5255 | 294.48 |
| 0.0088 | 51.8297 | 297.94 | 0.2684E+06 | 69.4208 | 294.50 |
| 0.0090 | 51.8267 | 297.93 | 0.2684E+06 | 69.3167 | 294.52 |
| 0.0092 | 51.8238 | 297.93 | 0.2684E+06 | 69.2134 | 294.54 |
| 0.0094 | 51.8208 | 297.92 | 0.2684E+06 | 69.1107 | 294.56 |
| 0.0096 | 51.8180 | 297.91 | 0.2684E+06 | 69.0087 | 294.58 |
| 0.0098 | 51.8151 | 297.90 | 0.2684E+06 | 68.9097 | 294.60 |
| 0.0100 | 51.8123 | 297.89 | 0.2684E+06 | 68.8067 | 294.62 |

Stop-Program terminated

As shown in Table 2-4, the data listed in the last line are the data of the two-fluid nozzle 200 at PT25, which are:

gas velocity: 51.8123 m/s;

gas temperature: 297.89 K;

pressure: 0.2684×10⁶ Pa;

liquid particle velocity: 68.8067 m/s.

In comparison, as shown in Table 1-2, the data listed in the last line are the data of the two-fluid nozzle 100 at PT13, which are:

gas velocity: 43.6308 m/s;

gas temperature: 297.81 K;

pressure: 0.3186×10⁶ Pa;

liquid particle velocity: 50.2845 m/s.

It can be known from the foregoing data, the two-fluid nozzle 200 employing a Venturi tube, produces liquid particles having a velocity of 68.8067 m/s at a position 5 mm apart from the exit orifice, while the conventional two-fluid nozzle 100 having no accelerating unit produces liquid particles having a velocity of 50.2845 m/s at a position 5 mm apart from the exit orifice. The difference between the velocities of the liquid particles is 18.5222 m/s. In other words, the accelerating unit effectively accelerates the liquid particles for 36.8%. However, it has also been noted that with respect to the two-fluid nozzle 200, a pressure loss from the accelerating unit to PT23 is 10.8. This indicates that there is still potential for further recycle using the pressure. Specifically, it is expectable to employ a plurality of accelerating units in the nozzle. As such, a two-fluid nozzle 300 employing two Venturi tubes 302 and 304 is illustrated below according to the second embodiment.

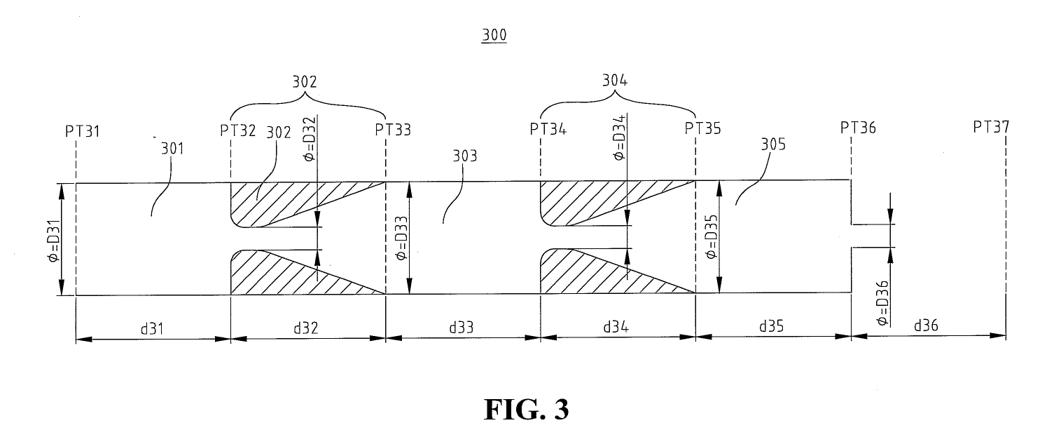

FIG. 3 is a schematic diagram illustrating a two-fluid nozzle 300 employing two Venturi tubes as an accelerating unit according to an embodiment of the present invention.

Referring to FIG. 3, the liquid particle velocity of the conventional two-fluid nozzle 100 having no accelerating unit is to be compared with the liquid particle velocity at the exit of the two-fluid nozzle 300 employing two accelerating units according to the embodiment of the present invention.

TABLE 3-1

| | | |
|---|---|---|
| PRESSURE = 0.3920E+06 PA | TEMPERATURE = 298.00 K | VELOCITY = 15.0000 M/S |
| INLET DIAMETER = 0.0060 M | EXIT DIAMETER = 0.0018 M | NOZZLE LENGTH = 0.0100 M |

| DISTANCE | VELOCITY | GAS TEMP. | PRESSURE | PARTICLE VEL. | PARTICLE TEMP. |
|---|---|---|---|---|---|
| (M) | (M/S) | (K) | (Pa) | (M/S) | (K) |
| 0.0000 | 15.0000 | 298.00 | 0.3920E+06 | 7.5000 | 298.00 |
| 0.0002 | 15.0840 | 298.00 | 0.3920E+06 | 7.7984 | 298.00 |
| 0.0004 | 15.3375 | 297.99 | 0.3919E+06 | 8.0809 | 298.00 |
| 0.0006 | 15.7692 | 297.98 | 0.3919E+06 | 8.3588 | 298.00 |
| 0.0008 | 16.3944 | 297.97 | 0.3918E+06 | 8.6420 | 298.00 |
| 0.0010 | 17.2353 | 297.95 | 0.3917E+06 | 8.9405 | 298.00 |
| 0.0012 | 18.3230 | 297.93 | 0.3916E+06 | 9.2643 | 298.00 |
| 0.0014 | 19.6984 | 297.91 | 0.3915E+06 | 9.6247 | 297.99 |
| 0.0016 | 21.4149 | 297.87 | 0.3913E+06 | 10.0349 | 297.99 |
| 0.0018 | 23.5417 | 297.82 | 0.3910E+06 | 10.5100 | 297.98 |
| 0.0020 | 26.1667 | 297.76 | 0.3906E+06 | 11.0685 | 297.98 |
| 0.0022 | 29.4014 | 297.67 | 0.3901E+06 | 11.7328 | 297.97 |
| 0.0024 | 33.3860 | 297.55 | 0.3894E+06 | 12.5298 | 297.95 |
| 0.0026 | 38.2949 | 297.38 | 0.3885E+06 | 13.4912 | 297.93 |
| 0.0028 | 44.3412 | 297.13 | 0.3871E+06 | 14.6552 | 297.90 |
| 0.0030 | 51.7799 | 296.79 | 0.3852E+06 | 16.0662 | 297.86 |
| 0.0032 | 60.9053 | 296.29 | 0.3825E+06 | 17.7744 | 297.81 |
| 0.0034 | 72.0395 | 295.57 | 0.3785E+06 | 19.8347 | 297.74 |
| 0.0036 | 85.5044 | 294.54 | 0.3730E+06 | 22.3032 | 297.64 |
| 0.0038 | 101.5696 | 293.29 | 0.3652E+06 | 25.2311 | 297.5 |
| 0.0040 | 120.3636 | 291.07 | 0.3546E+06 | 28.6551 | 297.32 |
| 0.0042 | 141.7328 | 288.36 | 0.3406E+06 | 32.5840 | 297.08 |
| 0.0044 | 165.0124 | 284.92 | 0.3234E+06 | 36.9815 | 296.78 |
| 0.0046 | 188.6384 | 280.90 | 0.3038E+06 | 41.7449 | 296.41 |
| 0.0048 | 209.4528 | 276.93 | 0.2846E+06 | 46.6802 | 295.99 |
| 0.0050 | 221.9946 | 274.41 | 0.2710E+06 | 51.4809 | 295.56 |
| 0.0052 | 220.5424 | 274.89 | 0.2683E+06 | 55.7619 | 295.16 |
| 0.0054 | 205.4619 | 278.20 | 0.2762E+06 | 59.2251 | 294.86 |

TABLE 3-2

| | | | | | |
|---|---|---|---|---|---|
| 0.0056 | 182.9184 | 282.62 | 0.2894E+06 | 61.7933 | 294.65 |
| 0.0058 | 158.4541 | 286.81 | 0.3031E+06 | 63.5612 | 294.53 |
| 0.0060 | 135.1086 | 290.22 | 0.3149E+06 | 64.6918 | 294.47 |
| 0.0062 | 114.2272 | 292.81 | 0.3244E+06 | 65.3538 | 294.44 |
| 0.0064 | 96.2417 | 294.68 | 0.3315E+06 | 65.6939 | 294.44 |
| 0.0066 | 81.1157 | 296.00 | 0.3367E+06 | 65.8305 | 294.45 |
| 0.0068 | 68.5896 | 296.93 | 0.3403E+06 | 65.8551 | 294.46 |
| 0.0070 | 58.3175 | 297.57 | 0.3429E+06 | 65.8338 | 294.47 |
| 0.0072 | 49.9396 | 298.01 | 03447E+06 | 65.7537 | 294.49 |
| 0.0074 | 43.1277 | 298.31 | 0.3460E+06 | 65.6055 | 294.52 |
| 0.0076 | 37.5961 | 298.52 | 0.3470E+06 | 65.3913 | 294.55 |
| 0.0078 | 33.1056 | 298.67 | 0.3476E+06 | 65.1173 | 294.59 |
| 0.0080 | 29.4601 | 298.77 | 0.3481E+06 | 64.7915 | 294.62 |
| 0.0082 | 26.5019 | 298.85 | 0.3485E+06 | 64.4218 | 294.66 |
| 0.0084 | 24.1051 | 298.90 | 0.3488E+06 | 64.0157 | 294.70 |
| 0.0086 | 22.1705 | 298.94 | 0.3490E+06 | 63.5800 | 294.74 |
| 0.0088 | 20.6204 | 298.97 | 0.3492E+06 | 63.1207 | 294.78 |
| 0.0090 | 19.3945 | 298.99 | 0.3493E+06 | 62.6433 | 294.83 |
| 0.0092 | 18.4465 | 299.00 | 0.3494E+06 | 62.1526 | 294.87 |
| 0.0094 | 17.7416 | 299.01 | 0.3495E+06 | 61.6528 | 294.91 |
| 0.0096 | 17.2545 | 299.01 | 0.3496E+06 | 61.1480 | 294.95 |
| 0.0098 | 16.9681 | 299.01 | 0.3496E+06 | 60.6417 | 295.00 |
| 0.0100 | 16.8725 | 299.01 | 0.3497E+06 | 60.1373 | 295.04 |

Stop-Program terminated

TABLE 3-3

| | | |
|---|---|---|
| PRESSURE = 0.3497E+06 PA | TEMPERATURE = 299.01 K | VELOCITY = 16.8725 M/S |
| INLET DIAMETER = 0.0060 M | EXIT DIAMETER = 0.0018 M | NOZZLE LENGTH = 0.0100 M |

| DISTANCE | VELOCITY | GAS TEMP. | PRESSURE | PARTICLE VEL. | PARTICLE TEMP. |
|---|---|---|---|---|---|
| (M) | (M/S) | (K) | (Pa) | (M/S) | (K) |
| 0.0000 | 16.8725 | 299.01 | 0.3497E+06 | 60.1373 | 295.04 |
| 0.0002 | 16.9644 | 299.00 | 0.3497E+06 | 59.6387 | 295.08 |
| 0.0004 | 17.2468 | 298.99 | 0.3497E+06 | 59.1487 | 295.12 |
| 0.0006 | 17.7297 | 298.98 | 0.3497E+06 | 58.6709 | 295.16 |
| 0.0008 | 18.4300 | 298.96 | 0.3497E+06 | 58.2088 | 295.20 |
| 0.0010 | 19.3726 | 298.94 | 0.3497E+06 | 57.7662 | 295.24 |
| 0.0012 | 20.5921 | 298.91 | 0.3496E+06 | 57.3474 | 295.28 |
| 0.0014 | 22.1346 | 298.87 | 0.3495E+06 | 56.9569 | 295.32 |
| 0.0016 | 24.0600 | 298.81 | 0.3494E+06 | 56.5999 | 295.36 |
| 0.0018 | 26.4455 | 298.74 | 0.3492E+06 | 56.2819 | 295.39 |
| 0.0020 | 29.3899 | 298.65 | 0.3488E+06 | 56.0087 | 295.42 |
| 0.0022 | 33.0184 | 298.53 | 0.3484E+06 | 55.7864 | 295.45 |
| 0.0024 | 37.4884 | 298.36 | 0.3478E+06 | 55.6207 | 295.48 |
| 0.0026 | 42.9958 | 298.13 | 0.3469E+06 | 55.5149 | 295.50 |
| 0.0028 | 49.7804 | 297.80 | 0.3456E+06 | 55.4676 | 295.51 |
| 0.0030 | 58.1295 | 297.35 | 0.3438E+06 | 55.4642 | 295.52 |
| 0.0032 | 68.3744 | 296.69 | 0.3412E+06 | 55.5169 | 295.53 |
| 0.0034 | 80.8850 | 295.76 | 0.3374E+06 | 55.6906 | 295.53 |
| 0.0036 | 96.0447 | 294.41 | 0.3319E+06 | 56.0659 | 295.53 |
| 0.0038 | 114.2078 | 295.20 | 0.3241E+06 | 56.7410 | 295.50 |
| 0.0040 | 135.6353 | 289.84 | 0.3133E+06 | 57.8264 | 295.43 |
| 0.0042 | 160.4058 | 286.20 | 0.2988E+06 | 59.4311 | 295.32 |
| 0.0044 | 188.2957 | 281.41 | 0.2799E+06 | 61.6392 | 295.14 |
| 0.0046 | 218.5909 | 275.35 | 0.2570E+06 | 64.4800 | 294.87 |
| 0.0048 | 249.5154 | 268.27 | 0.2315E+06 | 67.8983 | 294.51 |
| 0.0050 | 275.0249 | 261.79 | 0.2087E+06 | 71.6982 | 294.07 |
| 0.0052 | 274.1821 | 262.21 | 0.2059E+06 | 75.3599 | 293.63 |
| 0.0054 | 245.9218 | 269.66 | 0.2237E+06 | 78.2807 | 293.31 |

TABLE 3-4

| | | | | | |
|---|---|---|---|---|---|
| 0.0056 | 212.3624 | 277.39 | 0.2447E+06 | 80.3610 | 293.11 |
| 0.0058 | 180.5033 | 283.65 | 0.2631E+06 | 81.7303 | 293.00 |
| 0.0060 | 152.1328 | 288.35 | 0.2779E+06 | 82.5567 | 292.94 |
| 0.0062 | 127.6941 | 291.75 | 0.2892E+06 | 82.9981 | 292.93 |
| 0.0064 | 107.0963 | 294.15 | 0.2974E+06 | 83.1880 | 292.93 |
| 0.0066 | 89.9985 | 295.82 | 0.3033E+06 | 83.2331 | 292.94 |
| 0.0068 | 75.9551 | 296.97 | 0.3074E+06 | 83.2167 | 292.96 |
| 0.0070 | 64.4950 | 297.76 | 0.3103E+06 | 83.1417 | 292.98 |
| 0.0072 | 55.1795 | 298.30 | 0.3123E+06 | 82.9902 | 293.01 |
| 0.0074 | 47.6225 | 298.68 | 0.3138E+06 | 82.7621 | 293.04 |
| 0.0076 | 41.4957 | 298.94 | 0.3148E+06 | 82.4637 | 293.09 |
| 0.0078 | 36.5275 | 299.12 | 0.3156E+06 | 82.1036 | 293.13 |
| 0.0080 | 32.4978 | 299.26 | 0.3161E+06 | 81.6909 | 293.18 |
| 0.0082 | 29.2291 | 299.35 | 0.3165E+06 | 81.2345 | 293.23 |
| 0.0084 | 26.5822 | 299.43 | 0.3169E+06 | 80.7418 | 293.28 |
| 0.0086 | 24.4464 | 299.48 | 0.3171E+06 | 80.2199 | 293.33 |
| 0.0088 | 22.7355 | 299.52 | 0.3173E+06 | 79.6749 | 293.38 |
| 0.0090 | 21.3826 | 299.55 | 0.3175E+06 | 79.1123 | 293.43 |
| 0.0092 | 20.3365 | 299.57 | 0.3176E+06 | 78.5366 | 293.49 |
| 0.0094 | 19.5587 | 299.59 | 0.3177E+06 | 77.9522 | 293.54 |
| 0.0096 | 19.0213 | 299.60 | 0.3178E+06 | 77.3629 | 293.59 |
| 0.0098 | 18.7052 | 299.61 | 0.3178E+06 | 76.7722 | 293.65 |
| 0.0100 | 18.5996 | 299.61 | 0.3179E+06 | 76.1836 | 293.70 |

Stop-Program terminated.
GAS AND LIQUID OROPLET FLOW IN A NOZZLE

TABLE 3-5

| | | |
|---|---|---|
| PRESSURE = 0.3197E+06 PA | TEMPERATURE = 299.61 K | VELOCITY = 18.5996 M/S |
| INLET DIAMETER = 0.0060 M | EXIT DIAMETER = 0.0018 M | NOZZLE LENGTH = 0.0100 M |

| DISTANCE | VELOCITY | GAS TEMP. | PRESSURE | PARTICLE VEL. | PARTICLE TEMP. |
|---|---|---|---|---|---|
| (M) | (M/S) | (K) | (Pa) | (M/S) | (K) |
| 0.0000 | 18.5996 | 299.61 | 0.3179E+06 | 76.1836 | 293.70 |
| 0.0002 | 18.6958 | 299.61 | 0.3179E+06 | 75.5979 | 293.75 |
| 0.0004 | 18.9918 | 299.60 | 0.3180E+06 | 75.0206 | 293.81 |
| 0.0006 | 19.4974 | 299.59 | 0.3180E+06 | 74.4549 | 293.86 |
| 0.0008 | 20.2289 | 299.58 | 0.3179E+06 | 73.9041 | 293.91 |
| 0.0010 | 21.2104 | 299.55 | 0.3179E+06 | 73.3717 | 293.96 |
| 0.0012 | 22.4749 | 299.52 | 0.3178E+06 | 72.8618 | 294.01 |
| 0.0014 | 24.0661 | 299.48 | 0.3177E+06 | 72.3786 | 294.06 |
| 0.0016 | 26.0400 | 299.42 | 0.3176E+06 | 71.9268 | 294.11 |
| 0.0018 | 28.4675 | 299.35 | 0.3174E+06 | 71.5117 | 294.15 |
| 0.0020 | 31.4378 | 299.25 | 0.3171E+06 | 71.1391 | 294.20 |
| 0.0022 | 35.0611 | 299.12 | 0.3167E+06 | 70.8151 | 294.24 |
| 0.0024 | 39.4727 | 298.95 | 0.3161E+06 | 70.5462 | 294.27 |
| 0.0026 | 44.8349 | 298.741 | 0.3153E+06 | 70.3379 | 294.31 |
| 0.0028 | 51.3388 | 298.38 | 0.3142E+06 | 70.1940 | 294.34 |
| 0.0030 | 59.2014 | 297.94 | 0.3126E+06 | 70.1145 | 294.36 |
| 0.0032 | 68.6557 | 297.33 | 0.3104E+06 | 70.0899 | 294.37 |
| 0.0034 | 79.9288 | 296.49 | 0.3073E+06 | 70.1047 | 294.38 |
| 0.0036 | 93.2066 | 295.33 | 0.3031E+06 | 70.2062 | 294.39 |
| 0.0038 | 108.5761 | 293.78 | 0.2975E+06 | 70.4566 | 294.39 |
| 0.0040 | 125.9293 | 291.74 | 0.2901E+06 | 70.9218 | 294.37 |
| 0.0042 | 144.8248 | 289.19 | 0.2809E+06 | 71.6636 | 294.32 |
| 0.0044 | 164.2888 | 286.20 | 0.2701E+06 | 72.7234 | 294.25 |
| 0.0046 | 182.5383 | 283.07 | 0.2589E+06 | 74.1004 | 294.13 |
| 0.0048 | 196.7513 | 280.42 | 0.2492E+06 | 75.7283 | 293.99 |
| 0.0050 | 203.4353 | 279.13 | 0.2437E+06 | 77.4653 | 293.83 |
| 0.0052 | 46.9296 | 298.64 | 0.2824E+06 | 77.2310 | 293.86 |

TABLE 3-6

| | | | | | |
|---|---|---|---|---|---|
| 0.0054 | 46.9240 | 298.63 | 0.2824E+06 | 77.0229 | 293.89 |
| 0.0056 | 46.9184 | 298.62 | 0.2825E+06 | 76.8164 | 293.92 |
| 0.0058 | 46.9129 | 298.61 | 0.2825E+06 | 76.6113 | 293.96 |
| 0.0060 | 46.9074 | 298.60 | 0.2825E+06 | 76.4077 | 239.99 |
| 0.0062 | 46.9020 | 298.59 | 0.2825E+06 | 76.2056 | 294.02 |
| 0.0064 | 46.8966 | 298.58 | 0.2826E+06 | 76.0049 | 294.05 |
| 0.0066 | 46.8913 | 298.57 | 0.2826E+06 | 75.8057 | 294.08 |
| 0.0068 | 46.8860 | 298.56 | 0.2826E+06 | 75.6079 | 294.11 |
| 0.0070 | 46.8808 | 298.55 | 0.2826E+06 | 75.4116 | 294.14 |
| 0.0072 | 46.8756 | 298.54 | 0.2827E+06 | 75.2167 | 294.17 |
| 0.0074 | 46.8705 | 298.53 | 0.2827E+06 | 75.0231 | 294.20 |
| 0.0076 | 46.8654 | 298.52 | 0.2827E+06 | 74.8310 | 294.22 |
| 0.0078 | 46.8604 | 298.51 | 0.2827E+06 | 74.6403 | 294.25 |
| 0.0080 | 46.8554 | 298.50 | 0.2827E+06 | 74.4509 | 294.28 |
| 0.0082 | 46.8505 | 298.49 | 0.2828E+06 | 74.2629 | 294.31 |
| 0.0084 | 46.8456 | 298.48 | 0.2828E+06 | 74.0762 | 294.34 |
| 0.0086 | 46.8407 | 298.48 | 0.2828E+06 | 73.8910 | 294.36 |
| 0.0088 | 46.8360 | 298.47 | 0.2828E+06 | 73.7070 | 294.39 |
| 0.0090 | 46.8312 | 298.46 | 0.2828E+06 | 73.5244 | 294.42 |
| 0.0092 | 46.8265 | 298.45 | 0.2829E+06 | 73.3431 | 294.45 |
| 0.0094 | 46.8218 | 298.44 | 0.2829E+06 | 73.1631 | 294.47 |
| 0.0096 | 46.8172 | 298.43 | 0.2829E+06 | 72.9844 | 294.50 |
| 0.0098 | 46.8127 | 298.42 | 0.2829E+06 | 72.8070 | 294.52 |
| 0.0100 | 46.8082 | 298.41 | 0.2829E+06 | 72.6309 | 294.55 |

Stop-Program terminated
Press any key to continue

FIG. 3 is a schematic diagram illustrating a two-fluid nozzle 300 employing two Venturi tubes as an accelerating unit according to an embodiment of the present invention. The two-fluid nozzle 300 includes left-to-right sequentially disposed a mixing chamber 301, a Venturi tube 302, a recovery portion 303, a Venturi tube 304, a recovery portion 305, and an exit orifice 306.

Conditions of the two-fluid nozzle 300 are listed below:

(a) in the mixing chamber 301,
gas velocity: 15 m/s;
liquid particle velocity: 7.5 m/s;
liquid particle size: 30 μm;
temperature: 25° C.;
pressure: 3 kg/cm²G;
inner diameter of chamber, D31: 6 m/m;

(b) length from PT31 to PT32, d31: 5 mm,

(c) Venturi tube 302,
Diameter, D32: 1.8 m/m;

(d) length from PT32 to PT33, d32: 5 mm;

(e) recovery portion 303,
Diameter, D33: 6 m/m;

(f) length from PT33 to PT34, d33: 5 mm;

(g) Venturi tube 304,
Diameter, D34: 1.8 m/m;

(h) length from PT34 to PT35, d34: 5 mm;

(i) recovery portion 305,
diameter, D35: 6 m/m;

(j) length from PT35 to PT36, d35: 5 mm;

(k) exit orifice 306,
exit orifice diameter, D36: 2.0 m/m

(l) length from PT36 to PT37, d36: 5 min.

In accordance the foregoing embodiment, all conditions except the accelerating unit of the conventional nozzle and the present invention are equivalent, and it is assumed that the liquid particles maintain their size (30 μm) unchanged when accelerating the particle velocity. According to a one-dimensional calculation, and numerical analysis is made to the foregoing, results are listed in Tables 3-1, 3-2, 3-3, 3-4, 3-5, and 3-6. As shown in Table 3-6, data listed in the last line of Table 3-6 are the data of the two-fluid nozzle 300 at PT37 (positioned 5 mm to the exit), which are:

gas velocity: 46.8082 m/s;

gas temperature: 298.41 K;

pressure: 0.2829E+6 Pa;

liquid particle velocity: 72.6306 m/s.

It can be known from the comparison of the foregoing data, the two-fluid nozzle 300 employing two accelerating units, produces liquid particles having a velocity of 72.6306 m/s at a position 5 mm apart from the exit, while the conventional two-fluid nozzle 100 having no accelerating unit produces liquid particles having a velocity of 50.2845 m/s at a position 5 mm apart from the exit orifice. The difference between the velocities of the liquid particles is 22.3461 m/s. In other words, the accelerating unit effectively accelerates the liquid particles for 44.4%.

It can be concluded from the foregoing two embodiments that under the conditions of not increasing gas pressure and the diameter of exit orifices (2 m/m) of the two-fluid nozzles 200 and 300 being not smaller than the diameter of exit orifice (1.8 m/m) of the conventional two-fluid nozzle 100 having no accelerating unit, the liquid particles passing through the accelerating unit are effectively accelerated.

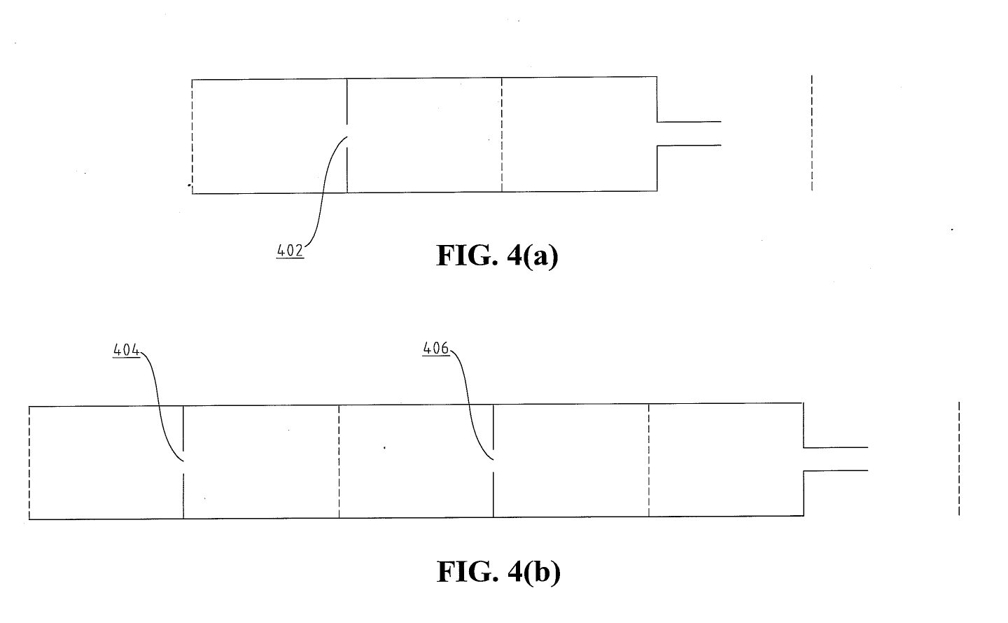

FIG. 4a is a schematic diagram illustrating a two-fluid nozzle employing an orifice as an accelerating unit according to an embodiment of the present invention.

FIG. 4b is a schematic diagram illustrating a two-fluid nozzle employing two orifices as an accelerating unit according to an embodiment of the present invention.

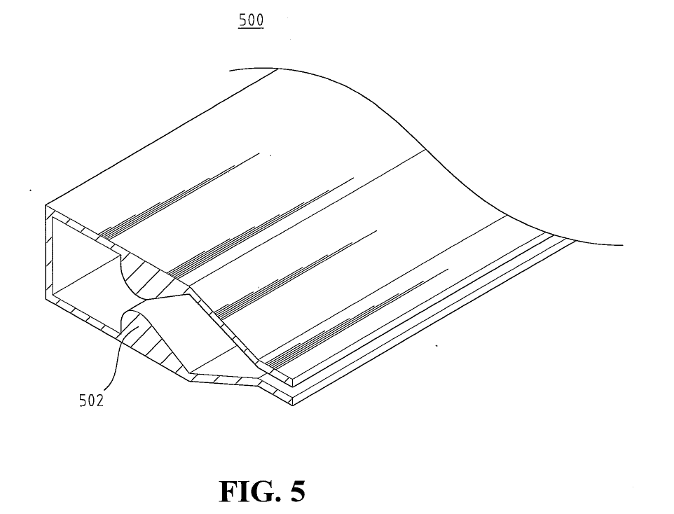

FIG. 5 is a schematic diagram illustrating a gas knife type atomizer employing a Verturi tube as an accelerating unit according to an embodiment of the present invention. The Venturi tube 502 is employed in a gas knife type atomizer 400, and is adapted for uniformly spraying two-fluid particles with an accelerated velocity on to a surface of a desired object.

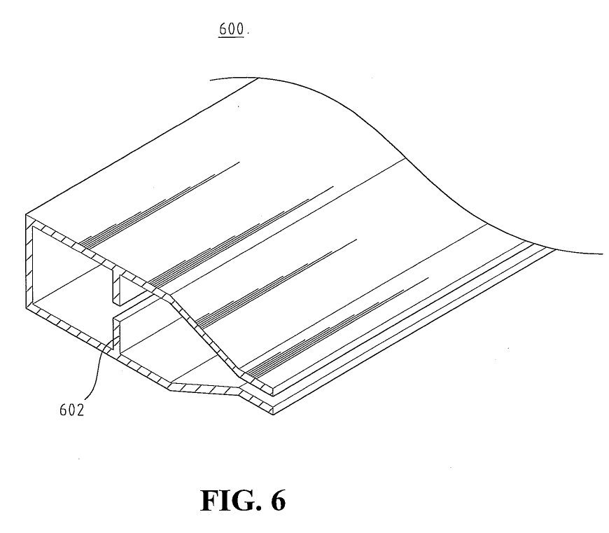

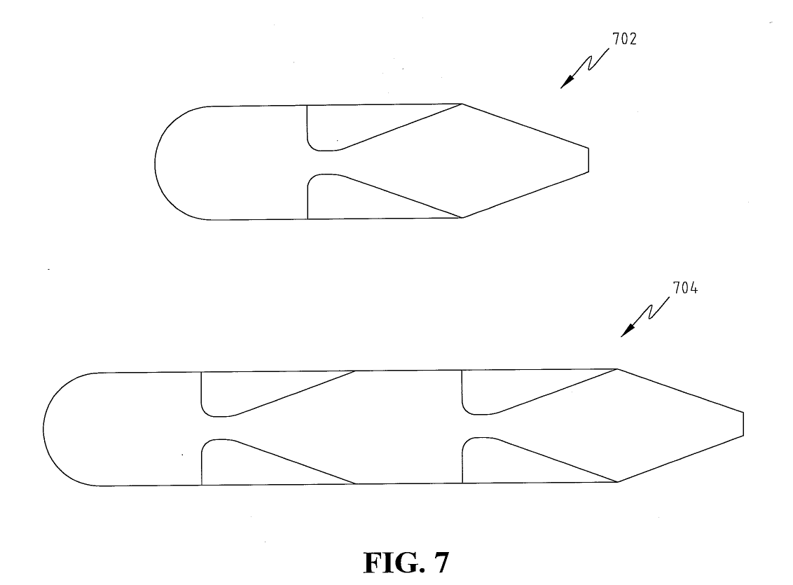

FIG. 6 is a schematic diagram illustrating a gas knife type atomizer employing an orifice as an accelerating unit according to an embodiment of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A fluid ejection device, comprising:
a chamber, allowing a fluid flowing therein and mixed therein;
at least one accelerating unit, disposed in and connected to the chamber, for accelerating the fluid in the chamber; and
an exit, for outputting the fluid, connected to an end of the accelerating unit.

2. The fluid ejection device according to claim 1, wherein the fluid ejection device is a two-fluid sprayer.

3. The fluid ejection device according to claim 2, wherein the two-fluid sprayer is a nozzle.

4. The fluid ejection device according to claim 2, wherein the two-fluid sprayer is a gas knife type atomizer.

5. The fluid ejection device according to claim 1, wherein the accelerating unit comprises at least one Venturi tube.

6. The fluid ejection device according to claim 1, wherein the accelerating unit comprises at least one orifice.
